(19) United States
(12) Patent Application Publication
(10) Pub. No.: US 2026/0155290 A1
(43) Pub. Date: Jun. 4, 2026

(54) ELECTROMAGNETIC APPARATUS, AND METHOD FOR PRODUCING SUCH AN ELECTROMAGNETIC APPARATUS

(71) Applicant: KNORR-BREMSE SYSTEME FÜR SCHIENENFAHRZEUGE GMBH, München (DE)

(72) Inventors: Ralf Woerner, Tiefenbronn (DE); Friedbert Roether, Cleebronn (DE); Benjamin Jensen, Grossbottwar (DE)

(21) Appl. No.: 18/715,081

(22) PCT Filed: Dec. 14, 2022
(86) PCT No.: PCT/EP2022/085879

§ 371 Date: May 30, 2024

(30) Foreign Application Priority Data
Dec. 15, 2021 (DE) 10 2021 133 231.1

(51) Int. Cl. H01F 27/24; H01F 7/08; H01F 27/28; H01F 41/02; H01F 41/04

(52) U.S. Cl. CPC H01F 27/24; H01F 7/08; H01F 27/28; H01F 41/0206; H01F 41/04

(57) ABSTRACT

An electromagnetic apparatus includes a magnetic core having a longitudinal axis and a coil former that is circumferentially disposed around the magnetic core and has at least one receiving region for receiving at least one coil winding of a coil, in which the receiving region is formed by at least one wall of coil former material, the wall having a first portion extending in the direction of the longitudinal axis of the magnetic core and at least one second portion extending transversely to the longitudinal axis of the magnetic core. The magnetic core has a circumferential fastening portion which has a tooth-like contour in cross-section along the longitudinal axis of the magnetic core and is interlocked with the coil former material of the coil former by displacement of coil former material so that the magnetic core is held on the coil former by the circumferential fastening portion.

### FIELD OF THE INVENTION

The present invention relates to an electromagnetic apparatus with a magnetic core and a coil body arranged circumferentially around the magnetic core, and to a method for producing such an electromagnetic apparatus.

### BACKGROUND INFORMATION

Such electromagnetic apparatuses are used, for example, in electromagnetic actuators, wherein electromagnetic actuators, for example in the form of electromagnetic switch or valve apparatuses such as, for example, in the form of an electromagnetic relay or solenoid valve, are known. Solenoid valves, for example in the form of tilting armature valves, are used, for example, as control valves for regulating the pressure of air, for example in a vehicle, such as for example in a commercial vehicle or bus for transporting passengers. For example, a brake system for a vehicle with an electronic service brake system comprises at least one control valve for pressure regulation.

An electromagnetic actuator in the form of a tilting armature valve which has an electromagnetic apparatus is discussed, for example, in DE 10 2016 105 532 A1. The electromagnetic actuator features an electromagnetic apparatus which comprises a magnetic core and a coil body arranged around the latter.

Further types of solenoid valves are understood, as discussed for example in DE 10 2014 115 207 A1, DE 10 2018 123 997 A1, or DE 10 2014 115 206 B3.

Generally, in the case of electromagnetic apparatuses, the coil body is attached to the magnetic core by overmolding in order to establish a connection between the coil body and the magnetic core. In other electromagnetic apparatuses, the coil body is, for example, split in the longitudinal direction in order to position the magnetic core between the coil body halves. The coil body halves are then assembled and the magnetic core thus fixed in the coil body. On the one hand, this production variant is complicated and, on the other hand, the coil body has a structural weakness because of this split.

### SUMMARY OF THE INVENTION

An object of the present invention is to specify an electromagnetic apparatus of the type mentioned at the beginning which can be produced relatively simply and quickly and which thus supplies a secure connection between the magnetic core and the coil body.

The invention relates to an electromagnetic apparatus of the type mentioned at the beginning according to the attached claims. Advantageous embodiments and developments of the invention are specified in the subclaims and the following description.

In particular, one aspect of the present invention relates to an electromagnetic apparatus with a magnetic core with a longitudinal axis and a coil body arranged circumferentially around the magnetic core. The coil body has at least one receiving region for receiving at least one coil winding of a coil, wherein the receiving region is formed by at least one wall which is made from the coil body material and has a first region which runs in the direction of the longitudinal axis of the magnetic core and at least one second region which runs transversely to the longitudinal axis of the magnetic core. The magnetic core has a circumferential fastening region which has a tooth-like contour in cross-section along the longitudinal axis of the magnetic core and, by displacement of the coil body material, is interlocked with the coil body material of the coil body such that the magnetic core is held on the coil body by the circumferential fastening region.

The invention enables the electromagnetic apparatus to be produced quickly and efficiently by the magnetic core being securely interlocked with the coil body by the circumferential fastening region of the magnetic core. This embodiment of the electromagnetic apparatus furthermore enables the magnetic core to be capable of being pushed into the coil body in the longitudinal direction and a secure connection to exist between the magnetic core and the coil body. The same also applies of course when the coil body is pushed onto the magnetic core. In order to avoid repetitions, pushing the magnetic core into the coil body is equivalent to pushing the coil body onto the magnetic core.

The electromagnetic apparatus furthermore permits a flexible choice of material for the magnetic core and the coil body. In the case of the known overmolding of the magnetic core from the prior art, it is instead necessary that the materials are matched with each other so that the overmolding material is held on the magnetic core.

A further advantage of the invention is that no additional components are needed to fasten the magnetic core securely in the coil body. The secure fastening is ensured by the circumferential fastening region of the magnetic core. Therefore only the magnetic core and the coil body are necessary in order to benefit from the advantages of the electromagnetic apparatus according to the invention. Compared with a two-part coil body, in the electromagnetic apparatus according to the invention there is no connection between the two coil body parts and a locking element which fixes the magnetic core in the two-part coil body.

During operation of the electromagnetic apparatus, the electromagnetic apparatus is in most cases warm, for example because of heat loss in the coil winding, and the coil body tends to expand. By the embodiment according to the invention of the electromagnetic apparatus, because of the circumferential fastening region and in spite of expansion of the coil body, the magnetic core remains securely connected to the coil body such that the magnetic core is secured against falling out of the coil body.

The electromagnetic apparatus according to the invention can in principle be used not only in electromagnetic actuators such as, for example, a tilting armature valve, and electromagnets, but also in relays. The electromagnetic apparatus according to the invention may be used, for example, in a solenoid valve, in a brake system of a vehicle, in particular a commercial vehicle.

According to an embodiment of the electromagnetic apparatus, the circumferential fastening region is configured such that the coil body material flows around the tooth-like contour and forms an undercut. This means that the coil body material which is displaced outward radially with respect to the longitudinal axis through the circumferential fastening region when the magnetic core is pushed into the coil body expands again in the push-in direction behind the fastening region and thus undercuts the circumferential fastening region. The word “flow” does not mean in this connection that the coil body material is in a liquid state when the magnetic core is pushed into the coil body and instead refers essentially to a displacement and/or a plastic deformation of coil body material such as, for example, plastic material. Secure fastening of the magnetic core in the coil body is ensured in every situation because of the undercut. Alternatively, the magnetic core can also be ultrasonically welded into the coil or the coil body via an ultrasonic welding process, i.e. be arranged and fastened therein.

According to an embodiment of the electromagnetic apparatus, the circumferential fastening region has a sawtooth contour in cross-section along the longitudinal axis of the magnetic core. The coil body can interlock or wedge securely and firmly with the magnetic core at the sawtooth contour. In particular, this sawtooth contour prevents the magnetic core from being able to inadvertently fall out of the coil body counter to a push-in direction. A reliable connection between the magnetic core and the coil body thus results.

According to an embodiment of the electromagnetic apparatus, the circumferential fastening region is arranged at a longitudinal position of the magnetic core at which no receiving region is situated in a direction perpendicular to the longitudinal axis of the magnetic core. In this region of the coil body, the coil body is stiffer than in the receiving region. This makes it possible that, after the magnetic core has been pushed in, the coil body firmly surrounds the circumferential fastening region of the magnet core and thus enables a secure connection between the coil body and the magnetic core.

According to an embodiment of the electromagnetic apparatus, it has a housing, in particular a magnet housing, which is arranged circumferentially around the coil body and exerts a pressing force, acting transversely, which may be perpendicularly, to the longitudinal axis of the magnetic core, on the wall of the receiving region. During operation of the electromagnetic apparatus, the coil body heats up and expands. By virtue of the expansion of the coil body, the coil body is supported on the magnet housing and imparts a force to the circumferential fastening region of the magnetic core such that the undercutting of the coil body behind the circumferential fastening region is accentuated. This results in secure fastening of the magnetic core in the coil body.

According to an embodiment of the electromagnetic apparatus, the magnetic core has a plurality of circumferential fastening regions along the longitudinal axis which each have a tooth-like contour in cross-section along the longitudinal axis of the magnetic core.

The plurality of fastening regions enable the coil body to bear, viewed in a longitudinal direction, against the magnetic core in a plurality of subregions and the coil body thus forms a plurality of undercuts. This results in a plurality of fastening points for the magnetic core in the coil body. Secure fastening of the magnetic core in the coil body is enabled.

According to an embodiment of the electromagnetic apparatus, a respective extent increases, in a direction perpendicular to the longitudinal axis of the magnetic core of the respective tooth-like contour, from one of the fastening regions to the fastening region following it along the longitudinal axis of the magnetic core. In particular, the extent increases in the push-in direction of the magnetic core into the coil body. This configuration enables the formation of a plurality of advantageous undercuts by the coil body, which means a further improvement in the fastening between the magnetic core and the coil body.

According to an embodiment of the electromagnetic apparatus, the circumferential fastening region has, in cross-section along the longitudinal axis of the magnetic core, a contour with a head region which has a flattened configuration. The head region which has a flattened configuration provides for the coil body a region which the coil body can undercut in order to fix the magnetic core. The head region which has a flattened configuration enables the magnetic core to be gripped in the coil body when the magnetic core is moved in the coil body in the opposite direction to the push-in direction. The push-in direction of the magnetic core runs along the longitudinal axis of the magnetic core. Reliable fastening of the magnetic core in the coil body is achieved as a result.

According to an embodiment of the electromagnetic apparatus, the circumferential fastening region has a contour with a depression in the magnetic core in cross-section along the longitudinal axis of the magnetic core, which contour has a smaller external radius than the magnetic core outside the fastening region. The depression in the circumferential fastening region enables the circumferential fastening region to have a higher flexibility than when there is no depression. This allows the magnetic core to be pushed into the coil body more easily.

According to an embodiment of the electromagnetic apparatus, the tooth-like contour has, on a side running transversely to the longitudinal axis of the magnetic core, an angle of no more than 90° to the outer side of the magnetic core outside the fastening region. When the coil body material expands behind the tooth-like contour thus configured and forms an undercut, the magnetic core sits firmly in the coil body. When the magnetic core moves counter to the push-in direction, this configuration enables the fastening region to be gripped against the coil body. It can thus be effectively avoided that the magnetic core is inadvertently pulled out from the coil body.

According to an embodiment of the electromagnetic apparatus, the coil body material has a plastic material. Production of a coil body with such a coil body material is favorable and simple and enables flexible deformation of the coil body. In particular, the plastic material can be the main constituent of the coil body material. The plastic material can have an elastomer as a constituent or as the main constituent. The coil body can, however, also be formed entirely from a plastic, in particular an elastomer.

According to an embodiment, the electromagnetic apparatus takes the form of an electromagnetic actuator. This is an advantageous embodiment of the electromagnetic apparatus according to the invention.

According to an embodiment of the electromagnetic apparatus, the electromagnetic apparatus has a movable magnetic armature body as the movable actuator element which can be moved by a magnetic field caused by a flow of current through the coil and the magnetic core. Reliable switching of an electromagnetic actuator is enabled as a result.

According to an embodiment, the electromagnetic apparatus takes the form of an electromagnetic switch or valve device with a movable magnetic armature body as a switch or valve element which can be moved by a magnetic field caused by a flow of current through the coil and the magnetic core.

According to an embodiment, the electromagnetic apparatus takes the form of an electromechanical relay or solenoid valve.

According to an embodiment, the electromagnetic apparatus takes the form of a solenoid valve for a pressure regulation module of a vehicle.

A further aspect of the present invention is a method for producing an electromagnetic apparatus according to the invention which has the following steps:
supplying the magnetic core and the coil body;
pushing the magnetic core into the coil body or pushing the coil body onto the magnetic core until the circumferential fastening region of the magnetic core is surrounded by the coil body.

The embodiments and advantages mentioned in connection with the electromagnetic apparatus also relate to the method according to the invention. These are not repeated again in order to avoid repetitions.

According to an embodiment of the method, the coil body has a magnetic core receptacle into which the magnetic core is pushed.

According to an embodiment of the method, the method can have the method step: orienting the magnetic core relative to the magnetic core receptacle in the coil body such that the longitudinal axis of the magnetic core and a longitudinal axis of the magnetic core receptacle are aligned with each other.

The embodiments described herein can be applied alongside one another or also in any desired combination with one another.

The invention is explained in detail below on the basis of the figures illustrated in the drawings.

### BRIEF DESCRIPTION OF THE DRAWINGS

FIG. 1A shows a schematic illustration in cross-section of an exemplary tilting armature valve in which an electromagnetic apparatus according to the invention, as illustrated in FIG. 2, can in principle be applied.

FIG. 1B shows a schematic illustration in cross-section of an exemplary tilting armature valve in which an electromagnetic apparatus according to the invention, as illustrated in FIG. 2, can in principle be applied.

FIG. 2 shows a schematic illustration in cross-section of an embodiment of an electromagnetic apparatus according to the invention, as can be used for example in a tilting armature valve according to FIG. 1.

FIG. 3 shows a schematic enlarged illustration in cross-section of a circumferential fastening region of the electromagnetic apparatus according to the invention of FIG. 2.

### DETAILED DESCRIPTION

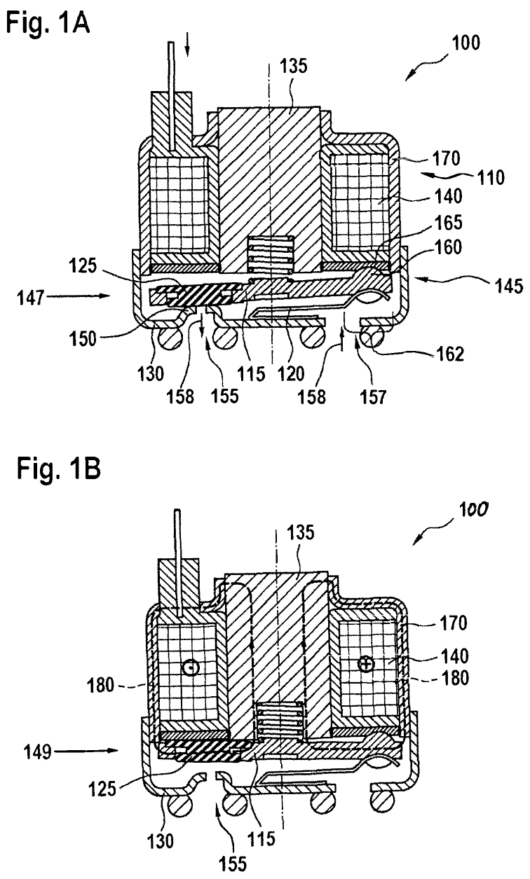

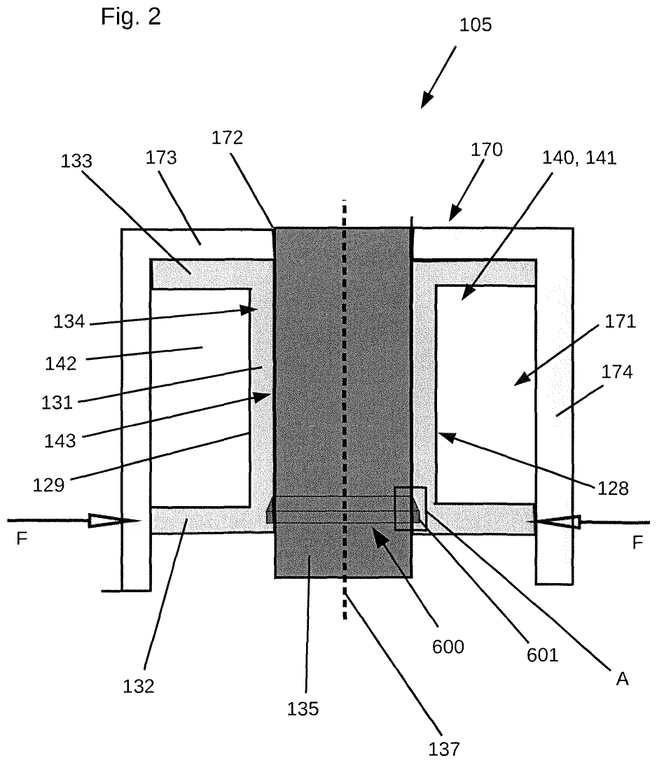

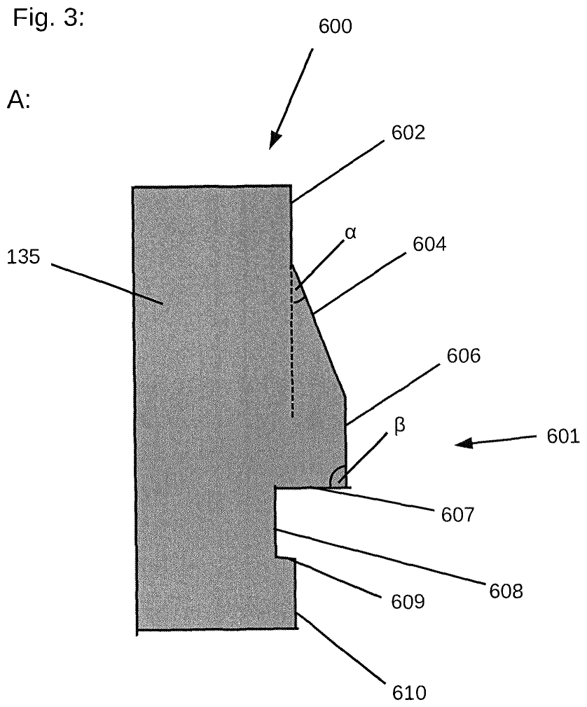

FIG. 1 shows with the aid of FIG. 1A and FIG. 1B a simplified illustration in cross-section of a tilting armature valve 100 in which an electromagnetic apparatus according to the invention, as illustrated in FIG. 2, can in principle be applied. FIG. 1 is intended here to illustrate the exemplary use in practice of an electromagnetic apparatus on the basis of a tilting armature valve. The configuration according to the invention of the magnetic core and the coil body is illustrated in detail here in FIG. 2 according to an exemplary embodiment and can in principle be readily transferred by a person skilled in the art to a tilting armature valve according to FIG. 1. In this connection, it should be pointed out that the fundamental operating principle of electromagnetic apparatuses such as switch or valve apparatuses with an armature body which can be moved by a magnetic field as a switch or valve element is known to a person skilled in the art. A circumferential fastening region according to an exemplary embodiment of the electromagnetic apparatus is illustrated in detail in FIG. 3.

The tilting armature valve 100 can, according to the fundamental principle, be an exemplary embodiment of a tilting armature valve 100 shown in DE 10 2016 105 532 A1. In a variant, it can here be a solenoid valve provided in FIG. 1 there with the reference sign 100. Other exemplary embodiments are, however, also conceivable, for example in connection with solenoid valves as described in the other abovementioned documents. Relevant embodiments of a solenoid valve described in DE 10 2016 105 532 A1 and their components and their use are by reference also part of the disclosure of the present invention.

FIG. 1A shows an illustration of a cross-section through a tilting armature valve 100, in which the armature is situated in the first position. The tilting armature valve 100 has a coil element 110, an armature body (or armature for short) 115, a spring 120, a sealing element 125, and a cover cap 130. The coil element 110 here comprises at least one magnetic core 135, a coil body 128 arranged circumferentially around the magnetic core 135, and a coil 140, arranged circumferentially around the coil body 128, with a stack of coil windings (not illustrated explicitly). An end side of the armature 115 is mounted by a bearing 145. The armature 115 can move between a first position 147 and a second position 149. The armature 115 is here configured to be moved from the first position 147 into a second (drawn-in) position 149 when the coil 140 is activated. When the coil 140 is activated, the armature 115 can be held in the second position 149. On that side of the armature 115 which faces away from the coil element 110, the sealing element 125 is furthermore arranged. Formed in the cover cap 130 is a valve seat 150 with an output 155 and an input 157 for a fluid 158. The output 155 can here be closed fluidtightly by the sealing element 125 when the armature 115 is arranged in the first position 147. The sealing element 125 can here moreover also act as a damping element in order to prevent the armature 115 striking the valve seat 150. The sealing element 125 can here be fastened by vulcanization on the armature 115 or a support element. It is moreover conceivable that an angle is produced when the armature 115 or sealing element 125 hits the valve seat 150 by an oblique nozzle or an obliquely shaped sealing element 125 or a curved armature 115. Such a nozzle, which is not illustrated explicitly in FIG. 1A, does not necessarily need to be integrated into the tilting armature valve 100 and instead can also be supplied by external housing parts.

It is moreover conceivable that the valve seat 150 is arranged in the coil element 110 but this is not illustrated explicitly in FIG. 1A for reasons of visibility. In this case, an actuator would then be advantageous which enables the output to be unblocked by the armature 115.

In this exemplary embodiment, the armature 115 has at least one at least partially round raised section 160 in a bearing portion 162, wherein the raised section 160 favorably engages in a recess 165 or opening which is arranged in a portion, situated opposite the raised section 160, of a housing 170 of the tilting armature valve 100. As a result, the armature 115 can slide in the recess in the case of movement from the first position 147 into the second position 149 after a flow of current through the coil 140 has been switched on and at the same time is held at a stationary position in the housing 170 or with respect to the cover cap 130. The recess is favorably configured as trapezoidal such that as little friction as possible is caused when the raised section slides over the surface of the recess 165. The recess 165 can be manufactured, for example, from plastic material and can consequently be produced very simply and cost-effectively.

In this example, the spring 120 takes the form of a leaf spring and is arranged in the bearing portion on a side, situated opposite the coil 140, of the armature 115. The spring 120 here serves to push, with no play, the ball bearing(s) which are for example press-fitted into the armature 115, into the (for example trapezoidal) mating shell or recess 165 in the housing 170 of the coil element 110. The armature 115 can be fixed by the spring 120 such that the armature 115 is held in a predetermined position by the spring 120. This affords the advantage that a constant pretensioning force can be exerted on the armature 115 and the force exerted on the armature 115 by the spring 120 can be imparted to the armature 115 as closely as possible to a force application point situated on the axis of rotation.

Alternatively, the armature 115 can also be suspended from the coil element 110. In this case, the spring 120, which takes the form for example of a leaf spring, could then be omitted.

FIG. 1B shows an illustration in cross-section through a tilting armature valve 100, in which the armature 115 is situated in the second position 149. In this case, a current through the coil 140 is switched on and the armature 115 drawn in such that a magnetic field illustrated by the field lines 180 is established. When the current through the coil 140 is switched off, the armature 115 can fall back into the first position 147, for example by virtue of gravity or a spring force of the illustrated return spring.

FIG. 2 shows a schematic illustration in cross-section of an embodiment of an electromagnetic apparatus according to the invention, as can be used for example in a tilting armature valve according to FIG. 1. The same, similar components or those with the same action are designated in FIGS. 1, 2, and 3 with the same reference signs.

In contrast to the tilting armature valve 100 according to FIG. 1, the electromagnetic apparatus 105 according to FIG. 2 has a coil element 110 in which the cylindrical magnetic core 135 comprises a circumferential fastening region 600 which has a tooth-like contour 601 in cross-section along the longitudinal axis 137 of the magnetic core 135. In the present exemplary embodiment, the magnetic core 135 is surrounded by the coil body 128 which may have a rotationally symmetrical configuration. The coil body 128 has a receiving region 142 for receiving at least one coil winding 141 of a coil 140 (not illustrated explicitly in FIG. 2). The circumferential fastening region 600 may be integrally formed with the magnetic core 135 but can in principle also be formed and attached separately.

The receiving region 142 is, viewed in cross-section, formed by a wall 129 which has a first region 131 which runs in the direction of the longitudinal axis 137 of the magnetic core 135, a second region 132 which runs transversely (which may be perpendicularly) to the longitudinal axis 137 of the magnetic core 135 and is arranged at a first end of the first region 131, and a third region 133 which likewise runs transversely (which may be perpendicularly) to the longitudinal axis 137 of the magnetic core 135 and is arranged at a second end of the first region 131. The first region 131, the second region 132, and the third region 133 of the wall 129 together form a trough-like or, as illustrated, U-shaped receiving region 142.

The coil body 128 has a magnetic core receptacle 143 which is formed by the first region 131 of the wall 129 of the receiving region 142. The magnetic core receptacle 143 is matched to the magnetic core 135 such that the magnetic core 135 can be pressed into the magnetic core receptacle 143 of the coil body 128. In particular, the magnetic core receptacle 143 has a cylindrical shape.

In an exemplary embodiment not shown, the receiving region 142 can also be formed by the first region 131 of the wall 129, the second region 132 of the wall 129, and a housing base 173 of the housing 170, wherein the housing 170 (in particular the magnet housing) is arranged at the second end of the first region 131.

The housing 170 has a pot-like shape with an inner region 171 which is formed such that the coil body 128 can, together with the magnetic core 135, be pressed into the housing 170. In the exemplary embodiment, the housing 170 has a central opening 172 in a housing base 173 in which the magnetic core 135 is pressed. If the housing 170 does not have such an opening, the magnetic core 135 can end, in the installed state, on the housing base 173 or in front of the latter in the push-in direction. The housing 170 has a circumferential side wall 174 which extends away from the housing base 173 in the longitudinal direction of the magnetic core 135 and thus delimits the inner region 171 in the radial direction. The internal diameter of the inner region 171 is here somewhat smaller than the external diameter of the coil body 128 such that, when the coil body 128 is pushed into the housing 170, a radial compression (illustrated by the pressing force F) is exerted on the coil body 128, in particular on radial outer ends of the second region 132 and the third region 133 of the wall 129 of the coil body 128. By virtue of the radial compression, an undercut of the coil body 128 behind the circumferential fastening region 600 is additionally promoted. In other words, the coil body can be configured as oversized at the side to be fixed such that a radial compression is exerted on the coil body when the housing is subsequently fitted. This compression promotes the formation of the geometrical undercut. By this radial compression, the magnetic core 135 is securely fastened in the coil body 128 such that, when the coil body 128 heats up during the operation of the electromagnetic apparatus 105, lifting-off of the coil body 128 from the magnetic core 135 can be mechanically avoided. The housing 170 may be configured as a single piece.

During operation, the electromagnetic apparatus 105 heats up as a result of the heat loss in the coil winding 141 such that the coil body 128 expands. By virtue of the expansion of the coil body 128, the coil body 128 is supported on the housing 170, which is illustrated in FIG. 2 by the force arrow F, and transmits the force to the circumferential fastening region 600 of the magnetic core 135. This means that the expansion of the coil body 128, in conjunction with the circumferential or closed housing 170, accentuates the undercut of the coil body 128 by the flow property of elastomers of the coil body material with the action of force behind the circumferential fastening region 600 and inhibits lifting-off from of the magnetic core 135 in the case of temperature expansion, whereby the magnetic core 135 is thus held securely in the coil body 128. The magnetic core 135 is, however, in principle also held securely in the coil body without a housing 170.

The housing 170 has magnetic material, as known to a person skilled in the art and described, for example, in DE 10 2016 105 532 A1.

The fastening region 600 at the circumference of the magnetic core 135 is arranged at an outer surface of the magnetic core 135 such that the circumferential fastening region 600 is in contact with the coil body 128, in particular with a radially internally situated surface, when the magnetic core 135 is pushed into the coil body 128. The first region 131 of the wall 129 delimits the magnetic core receptacle 143 in a radial direction relative to the longitudinal axis 137.

In the exemplary embodiment, the circumferential fastening region 600 is arranged on the magnetic core 135 such that the circumferential fastening region 600 is, when the magnetic core 135 is in its end push-in position in the coil body 128, arranged at the level of the second region 132 of the wall 129, viewed in the longitudinal direction. At this position, the coil body 128 is stiffer than at a position in the first region 131 such that the magnetic core 135 is advantageously fastened in the coil body 128. In other words, the circumferential fastening region 600 is arranged on the magnetic core 135 such that, in the end push-in position, the circumferential fastening region 600 is arranged in the longitudinal direction which may be outside the receiving region 143 on the coil body 128, i.e. outside the region in which the coil 140 can be wound around the coil body 128.

In an exemplary embodiment which is not shown, the circumferential fastening region 600 can, in the end push-in position, alternatively or additionally be arranged in the first region 131 of the wall 129. This enables the magnetic core 135 likewise to interlock with the coil body 128.

In a further exemplary embodiment which is not shown, the circumferential fastening region 600 can alternatively or additionally be arranged on the magnetic core 135 such that the circumferential fastening region 600 is arranged opposite the third region 133 of the wall 129 in the end push-in position. This exemplary embodiment too enables secure fastening of the magnetic core 135 in the coil body 128.

The magnetic core 135 can also have more than one circumferential fastening region 600 which are distributed on the magnetic core 135 in the longitudinal direction of the magnetic core 135. When there are three or more circumferential fastening regions 600, the three or more circumferential fastening regions 600 can be distributed uniformly or irregularly over a length of the magnetic core 135. Uniformly in this context means that the spacing between a first circumferential fastening region and a second circumferential fastening region is exactly the same as the spacing between the second circumferential fastening region and a third circumferential fastening region.

In the case that the magnetic core 135 has a plurality of circumferential fastening regions 600, a respective extent of the fastening region 600 can, in a direction perpendicular to the longitudinal axis 137 of the magnetic core 135 of the respective tooth-like contour 601, increase from one of the fastening regions 600 to the fastening region 600 following it along the longitudinal axis 137 of the magnetic core 135. It is advantageous here that the extent in a direction perpendicular to the longitudinal axis 137 of the magnetic core 135 (height of the raised section) of the fastening regions 600 situated one behind the other increases such that essentially always the same amount of coil body material needs to be displaced.

FIG. 3 shows a schematic and enlarged illustration in cross-section (detail A) of the circumferential fastening region 600 with the tooth-like contour 601 of the magnetic core 135.

A first end 602 of the circumferential fastening region 600 is arranged at the top in FIG. 3. When the magnetic core 135 is pushed into the coil body 128, the first end 602 of the circumferential fastening region 600 enters the coil body 128 first and then the tooth-like contour 601, which is described below by way of example, enters.

Starting from the first end 602, viewed in the push-in direction of the magnetic core 135 into the coil body 128, the diameter of the magnetic core 135 increases uniformly as far as a clamping region (head region) 606 of the circumferential fastening region 600 which has a larger diameter than the diameter of the magnetic core 135 outside the fastening region 600. This constantly increasing diameter of the circumferential fastening region 600 is situated in a widening region 604 of the circumferential fastening region 600. The widening region 604 in other words has a uniform slope as far as the external diameter of the clamping region 606.

An angle α, which is spanned by an extension of the diameter of the magnetic core 135 outside the fastening region 600 and a slope of the widening region 604, can have a value between, for example, 1 and 90 degrees, which may be between 10 and 35 degrees. By virtue of such a configuration of the widening region 604, the magnetic core 135 enables the coil body material 134 of the coil body 128 to flow around the tooth-like contour 601 and form an undercut behind the tooth-like contour 601 when it is pressed in without the internal diameter thus being permanently widened or even enlarged by machining. With such an angle α, it is moreover possible to reduce the fitting force for pressing the magnetic core 135 into the coil body 128 and to avoid coil body material being mechanical shaved off.

The external diameter of the clamping region 606 of the circumferential fastening region 600 remains more or less constant for a predetermined longitudinal portion (flattened head region), which advantageously promotes the flowing process during pressing in. This means that the external diameter of the clamping region 606 does not change over its length. It is followed in the push-in direction of the magnetic core 135 by a depression 608. This depression 608 can also be referred to as a neck. The depression 608 has a smaller diameter than the diameter of the magnetic core 135 outside the fastening region 600 and thus also a smaller diameter than the clamping region 606. A transition 607 from the clamping region 606 to the depression 608 is arranged in a radial plane. This means that the transition 607 may lead to the depression 608 at a right angle β from the clamping region 606 to the depression 608 and thus forms the tooth-like contour 601. Expressed in different terms, the tooth-like contour 601 has, on a side running transversely (which may be perpendicularly) to the longitudinal axis 137 of the magnetic core 135, an angle (β) of no more than 90° to the outer side of the magnetic core 135 outside the circumferential connecting region 600. In other words, the rear side of the tooth is configured as a sharp edge at an angle of no more than 90° such that the undercut can be formed and, in the case of stress counter to the fitting direction, gripping occurs.

In an exemplary embodiment not shown, the transition 607 can be configured such that the angle β is configured as an acute angle between the clamping region 606 and the transition 607, i.e. such that the angle β has a value of less than 90°.

The depression 608 is followed by a second end 610 of the circumferential fastening region 600, which second end has the diameter of the magnetic core 135 outside the fastening region 600. A transition 609 between the depression 608 and the second end 610 of the fastening region 600 is, for example, configured as slightly inclined and forms a steep ramp. Expressed in other terms, the diameter changes between the depression 608 and the second end 610 over a short length of the magnetic core 135 in the push-in direction.

In an exemplary embodiment not shown, the transition 609 can also be configured as perpendicular to the longitudinal axis of the magnetic core 135. This means that the magnetic core 135 enlarges abruptly, i.e. without a ramp-like transition, from the diameter of the depression 608 to the diameter of the magnetic core 135.

An electromagnetic apparatus according to the invention thus provides, in the case of the magnetic core 135, a circumferential fastening region 600 which is configured such that the coil body material flows around the tooth-like contour and forms an undercut, without simply just the internal diameter of the coil body here being widened or even enlarged by machining. Furthermore, in the case of temperature expansion of the coil body, the connection is supported and held securely in position. The invention also enables rapid fitting. The magnetic core can also be ultrasonically welded via an ultrasonic welding process via an ultrasonic welding system.

### THE LIST OF REFERENCE SIGNS IS AS FOLLOWS

100 tilting armature valve
105 electromagnetic apparatus
110 coil element
115 armature body
120 spring
125 sealing element
128 coil body
129 wall
130 cover cap
131 first region
132 second region
133 third region
134 coil body material
135 magnetic core
137 longitudinal axis
140 coil
141 coil winding
142 receiving region
143 magnetic core receptacle
145 bearing
147 first position
149 second position
150 valve seat
155 output
157 input
158 fluid
160 raised section
162 bearing portion
165 recess
170 housing
171 inner region
172 opening
173 housing base
174 side wall
180 field lines
600 circumferential fastening region
601 tooth-like contour
602 first end
604 widening region
606 clamping region
607 transition
608 depression
609 transition
610 second end
α angle
β angle

1-20. (canceled)

21. An electromagnetic apparatus, comprising:
a magnetic core with a longitudinal axis; and
a coil body arranged circumferentially around the magnetic core and which has at least one receiving region for receiving at least one coil winding of a coil;
wherein the receiving region is formed by at least one wall which is made from the coil body material and has a first region which runs in the direction of the longitudinal axis of the magnetic core and at least one second region which runs transversely to the longitudinal axis of the magnetic core, and
wherein the magnetic core has a circumferential fastening region which has a tooth-like contour in cross-section along the longitudinal axis of the magnetic core and, by displacement of the coil body material, is interlocked with the coil body material of the coil body such that the magnetic core is held on the coil body by the circumferential fastening region.

22. The electromagnetic apparatus of claim 21, wherein the circumferential fastening region is configured such that the coil body material flows around the tooth-like contour and forms an undercut.

23. The electromagnetic apparatus of claim 21, wherein the circumferential fastening region has a sawtooth contour in cross-section along the longitudinal axis of the magnetic core.

24. The electromagnetic apparatus of claim 21, wherein the circumferential fastening region is arranged at a longitudinal position of the magnetic core at which no receiving region, including the second region of the wall, is situated in a direction perpendicular to the longitudinal axis of the magnetic core.

25. The electromagnetic apparatus of claim 21, further comprising:
a housing, which is a magnet housing and which is arranged circumferentially around the coil body and exerts a pressing force, acting transversely to the longitudinal axis of the magnetic core, on the second region of the wall of the receiving region.

26. The electromagnetic apparatus of claim 21, wherein the magnetic core has a plurality of circumferential fastening regions along the longitudinal axis which each have a tooth-like contour in cross-section along the longitudinal axis of the magnetic core.

27. The electromagnetic apparatus of claim 26, wherein a respective extent increases, in a direction perpendicular to the longitudinal axis of the magnetic core of the respective tooth-like contour, from one of the fastening regions to the fastening region following it along the longitudinal axis of the magnetic core.

28. The electromagnetic apparatus of claim 21, wherein the circumferential fastening region has, in cross-section along the longitudinal axis of the magnetic core, a contour with a head region which has a flattened area.

29. The electromagnetic apparatus of claim 21, wherein the circumferential fastening region has a contour with a depression in the magnetic core in cross-section along the longitudinal axis of the magnetic core, which contour has a smaller external radius than the magnetic core outside the fastening region.

30. The electromagnetic apparatus of claim 21, wherein the tooth-like contour has, on a side running transversely to the longitudinal axis of the magnetic core, an angle of no more than 90° to the outer side of the magnetic core outside the fastening region.

31. The electromagnetic apparatus of claim 21, wherein the coil body material has a plastic material, or the magnetic core is ultrasonically welded into the coil body via an ultrasonic welding connection.

32. The electromagnetic apparatus of claim 21, wherein the electromagnetic apparatus is an electromagnetic actuator.

33. The electromagnetic apparatus of claim 32, further comprising:
a movable magnetic armature body as the movable actuator element which is movable by a magnetic field caused by a flow of current through the coil and the magnetic core.

34. The electromagnetic apparatus of claim 21, wherein the electromagnetic apparatus takes the form of an electromagnetic switch or valve apparatus with a movable magnetic armature body as a switch or valve element which is movable by a magnetic field caused by a flow of current through the coil and the magnetic core.

35. The electromagnetic apparatus of claim 21, wherein the electromagnetic apparatus includes an electromechanical relay or solenoid valve.

36. The electromagnetic apparatus of claim 21, wherein the electromagnetic apparatus includes a solenoid valve for a pressure regulation module of a vehicle.

37. A method for producing an electromagnetic apparatus, the method comprising:
supplying a magnetic core and a coil body; and
pushing the magnetic core into the coil body or pushing the coil body onto the magnetic core until a circumferential fastening region of the magnetic core is arranged in the coil body;
wherein the electromagnetic apparatus includes:
the magnetic core with a longitudinal axis; and
the coil body arranged circumferentially around the magnetic core and which has at least one receiving region for receiving at least one coil winding of a coil;
wherein the receiving region is formed by at least one wall which is made from a coil body material and has a first region which runs in the direction of the longitudinal axis of the magnetic core and at least one second region which runs transversely to the longitudinal axis of the magnetic core, and
wherein the magnetic core has a circumferential fastening region which has a tooth-like contour in cross-section along the longitudinal axis of the magnetic core, and which, by displacement of the coil body material, is interlocked with the coil body material of the coil body such that the magnetic core is held on the coil body by the circumferential fastening region.

38. The method of claim 37, wherein the coil body has a magnetic core receptacle into which the magnetic core is pushed.

39. The method of claim 38, further comprising:
orienting the magnetic core relative to the magnetic core receptacle in the coil body such that the longitudinal axis of the magnetic core and a longitudinal axis of the magnetic core receptacle are aligned with each other.

40. The method of claim 37, wherein the magnetic core is ultrasonically welded into the coil body via an ultrasonic welding connection.
